(19) United States
(12) Patent Application Publication
(10) Pub. No.: US 2014/0181427 A1
(43) Pub. Date: Jun. 26, 2014

(54) Compound Memory Operations in a Logic Layer of a Stacked Memory

(71) Applicant: ADVANCED MICRO DEVICES, INC., Sunnyvale, CA (US)

(72) Inventors: Nuwan S. JAYASENA, Sunnyvale, CA (US); James M. O'Connor, Austin, TX (US); Gabriel H. Loh, Bellevue, WA (US); Michael J. Schulte, Austin, TX (US); Bradford M. Beckmann, Redmond, WA (US); Michael Ignatowski, Austin, TX (US)

(73) Assignee: Advanced Micro Devices, Inc., Sunnyvale, CA (US)

(21) Appl. No.: 13/724,338

(22) Filed: Dec. 21, 2012

(51) Int. Cl. G06F 12/00

(52) U.S. Cl. CPC G06F 12/00
USPC 711/154

(57) ABSTRACT

Some die-stacked memories will contain a logic layer in addition to one or more layers of DRAM (or other memory technology). This logic layer may be a discrete logic die or logic on a silicon interposer associated with a stack of memory dies. Additional circuitry/functionality is placed on the logic layer to implement functionality to perform various data movement and address calculation operations. This functionality would allow compound memory operations—a single request communicated to the memory that characterizes the accesses and movement of many data items. This eliminates the performance and power overheads associated with communicating address and control information on a fine-grain, per-data-item basis from a host processor (or other device) to the memory. This approach also provides better visibility of macro-level memory access patterns to the memory system and may enable additional optimizations in scheduling memory accesses.

### BACKGROUND

1. Field

The disclosed embodiments relate generally to computer systems, and in particular to compound memory operations in memory management.

2. Background Art

Computer systems of various types are ubiquitous in modern society. Common to these computer systems is the storage of data in memory, from which processors perform read, write and other access instructions. A considerable portion of resources in computer systems is employed with the execution of these instructions.

Computer systems typically use processors, where the term “processor” generically refers to anything that accesses memory in a computing system. Processors typically load and store data to/from memory by issuing addresses and control commands on a per-data-item basis. Here a data item may be a byte, a word, a cache line, or the like, as the particular situation requires. These data accesses require a separate address and one or more commands to be transmitted from the processor to memory for each access even though the sequence of accesses follows a pre-defined pattern, such as a sequential stream. In some memory technologies, such as DRAM (dynamic random access memory), multiple commands may be required for some or all of the desired access.

The transmission of the memory addresses and associated commands consumes power and may introduce performance overheads in cases where the address/command bandwidth becomes a bottleneck. Furthermore, issuing addresses and control commands on a per-data-item basis may limit opportunities to optimize memory accesses and data transfers.

Transferring many data words in response to a single vector load/store or gather/scatter instruction has been a common feature in vector processors. One recent approach has proposed using “specialized warps” to load or store sequences of data stored in memory in sequential or strided access patterns. Another approach proposed loading and storing large amounts of data stored in memory using sequential, strided and indirect addressing with a single command from a processor. However, all of these approaches implement address generation on the processor die, and consequently issue a large number of memory access commands and addresses to the memory system, with each access command being directed to an address having a fine level of granularity.

### BRIEF SUMMARY OF THE EMBODIMENTS

Some embodiments move address generation and control logic to a logic layer stacked with memory to reduce performance and energy overheads. Some embodiments apply to die-stacked memories that contain a logic layer in addition to one or more layers of DRAM (or other memory technology). This logic layer may be a discrete logic die or logic on a silicon interposer associated with a stack of memory dies. Some embodiments place additional circuitry on the logic layer to implement functionality to perform various data movement and address calculation operations. This functionality enables compound memory operations, i.e., a single request communicated to the memory that characterizes the accesses and movement of many data items. This eliminates the performance and power overheads associated with communicating address and control information on a fine-grain, per-data-item basis from a host processor (or other device) to the memory. This approach also provides better visibility of macro-level memory access patterns to the memory system and may enable additional optimizations in scheduling memory accesses.

Some embodiments provide a method of and an apparatus for executing a compound instruction by a logic chip. The embodiments include receiving, by a logic chip, a compound instruction from a processor, where the compound instruction includes a memory access instruction and one or more descriptors. The logic chip and a memory chip form a memory device. The embodiments further include decoding, by the logic chip, the compound instruction to provide addresses of two or more data elements in the memory chip. The decoding is based on the one or more descriptors. Finally, the embodiments include accessing the two or more data elements based on the memory access instruction.

Further embodiments, features, and advantages of the disclosed embodiments, as well as the structure and operation of the various embodiments are described in detail below with reference to the accompanying drawings.

### BRIEF DESCRIPTION OF THE DRAWINGS/FIGURES

The accompanying drawings, which are incorporated herein and form part of the specification, illustrate the disclosed embodiments and, together with the description, further serve to explain the principles of the disclosed embodiments and to enable a person skilled in the relevant art(s) to make and use the disclosed embodiments.

FIG. 1 illustrates a multi-chip memory device, in accordance with an embodiment.

FIG. 2 illustrates an exemplary uni-dimensional strided memory access, in accordance with an embodiment.

FIG. 3 illustrates an exemplary two-dimensional strided memory access, in accordance with an embodiment.

FIG. 4 illustrates an exemplary indirect memory access, in accordance with an embodiment.

FIG. 5 illustrates an exemplary rotation of a uni-dimensional strided memory access, in accordance with an embodiment.

FIG. 6 illustrates an exemplary strided-indirect nested memory access, in accordance with an embodiment.

FIG. 7 provides a flowchart depicting a method for a compound memory access by a single memory request, in accordance with some embodiments.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the embodiments described below, memory systems can be implemented using multiple silicon chips within a single package, for example a memory chip three-dimensionally integrated with a logic/interface chip. The logic layer can be used to implement interconnect networks, built-in self-test, and memory scheduling logic. Some proposals to implement additional logic directly in the memory are expensive and have not proven to be practical because the placement of logic in a memory chip (as opposed to a separate logic chip as used by some embodiments) incur significant costs in the memory chips, and the performance is limited due to the inferior performance characteristics of the transistors used in memory manufacturing processes. Existing solutions rely on logic and functionality implemented directly in the memory chip with the disadvantages described above. Other existing solutions are implemented on an external chip (e.g., a memory controller on a central processing unit (CPU)/graphics processing unit (GPU) chip), which requires special logic and support on the CPU/GPU/memory controller and therefore requires additional data transfers between the CPU/GPU and memory.

Traditional memory chips implement all memory storage components and peripheral logic/circuits (e.g., row decoders, input/output (I/O) drivers, test logic) on a single silicon chip. Newer architectures propose a split of the memory cells into one or more silicon chips, and the placement of logic/circuits (or a subset of the logic and circuits) onto a separate logic chip. A separate logic chip offers an advantage in that it can be implemented with a different fabrication process technology that is better optimized for power and performance of the logic and circuits (the process used for memory chips is optimized for memory cell density and low leakage, and so the circuits implemented on these memory processes have very poor performance). The availability of a separate logic chip provides the opportunity to add value to the memory system by using the logic chip to implement additional functionality. In a further embodiment, the logic functionality can be implemented directly on an interposer, in which both the memory and the processor dies are stacked, rather than implementing this functionality on a separate logic chip.

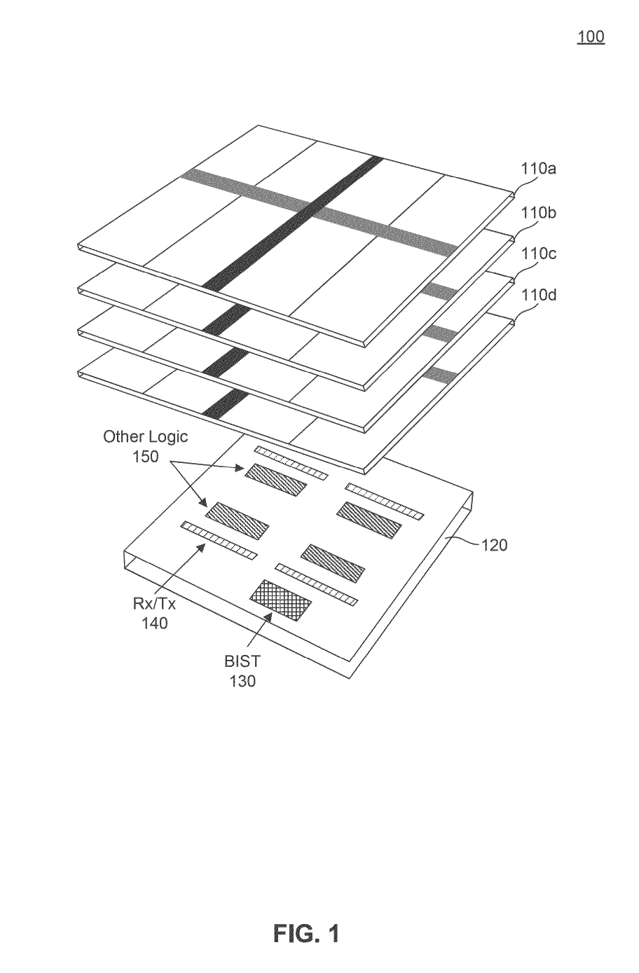

Current multi-chip integrated memories 100 include one logic layer 120 and one or more memory layers 110a-d, as illustrated in FIG. 1. Logic layer 120 can include receiver/transmit functionality 140, built-in-self-test functionality 130 and other logic 150. Current memory systems provide a simple interface (e.g., receiver/transmit functionality 140), which allows clients (e.g., any other component of a larger system that communicates with the memory, such as an integrated or discrete memory controller) to read or write data to/from the memory, along with a few other commands specific to memory operation, such as refresh and power down.

Some embodiments use this logic layer to implement functions to support compound memory operations on the data stored in the associated memory dies. Compound memory operations perform a sequence of memory accesses, such as stream transfers or gathers/scatters (gathers/scatters refers to a process of reading data from a data stream to multiple buffers/writing data from multiple buffers to a data stream), in response to a single command from a processor. The single command from the processor includes a descriptor of the memory access pattern to be performed. These descriptors may define various access patterns, such as (but not limited to) (1) sequential access; (2) uni-dimensional strided access; (3) multi-dimensional strided access; (4) uni-dimensional strided access with transpose; (5) indirect access; (6) application-specific patterns; (7) reversals; (8) rotations; and (9) nested combinations. Further details of each of these particular access patterns are provided below.

Sequential Accesses:

A sequential access involves a sequence of data elements stored contiguously in memory. In this case, an exemplary descriptor specifies: (a) a range of addresses (or start address and element count), and (b) optionally, the size of each data element for which access is warranted. The size of each data unit may include a standard unit of access, such as a byte, a word, or a larger aggregation, such as a data record with multiple fields.

Uni-Dimensional Strided Access:

A uni-dimensional strided access includes a sequence of data elements stored in memory, such that each adjacent pair of elements is separated by a constant addressing distance. In this case, an exemplary descriptor specifies: (a) a range of addresses (or start address and element count), (b) optionally, the size of each data element for which access is warranted, and (c) a stride. The size of each data unit may include a standard unit of access, such as a byte, a word, or a larger aggregation, such as a data record with multiple fields. In this context, a “stride” is the distance between adjacent data elements to be accessed. The stride may be specified in terms of a constant sized unit (e.g., bytes or words) or as a multiple of the data element size.

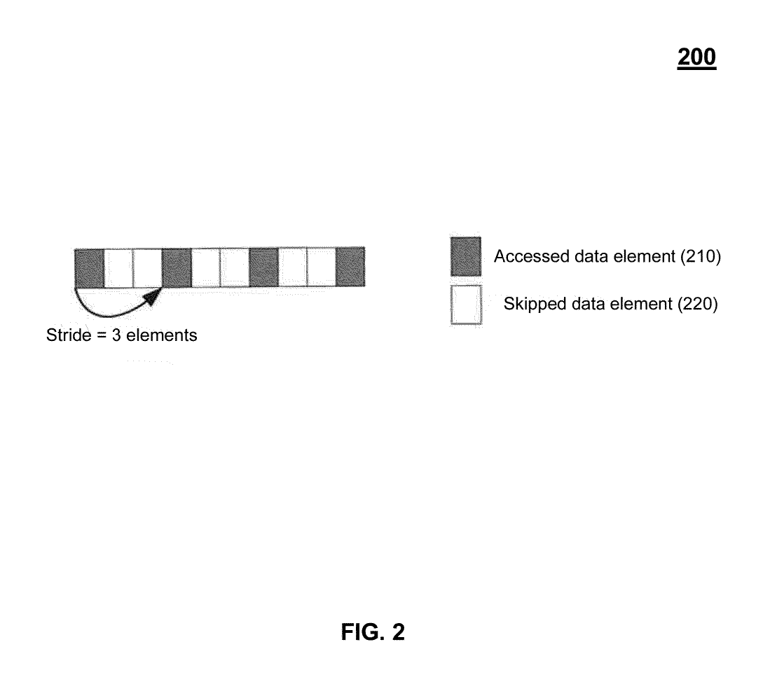

FIG. 2 illustrates an exemplary implementation of uni-dimensional strided access 200, with the sequential data elements divided into accessed data elements 210 and skipped data elements 220. In FIG. 2, the stride is three (3) elements, which is the distance between adjacent data elements to be accessed.

Multi-Dimensional Strided Access:

A multi-dimensional strided access includes a sequence of data elements belonging to a multidimensional array that is stored in memory, such that each adjacent pair of elements within each dimension is separated by a constant addressing distance. In this case, an exemplary descriptor specifies: (a) a range of addresses (or start address and element count), (b) optionally, the size of each data element for which access is warranted. The size of each data unit may include a standard unit of access, such as a byte, a word, or a larger aggregation, such as a data record with multiple fields, (c) the size of the data structure being accessed in all but the last dimension, either in terms of a constant sized unit (e.g., bytes or words) or as a multiple of the data element size, (d) “stride,” the distance between adjacent data elements, in each dimension. The stride may be specified in terms of a constant sized unit (e.g., bytes or words) or as a multiple of the data element size. Note that a stride of one (1) in any dimension degenerates the access to a sequential access along that dimension (this case may be optimized as a special case in some implementations of certain embodiments), and (e) optionally, a count of elements to access within each dimension may also be specified.

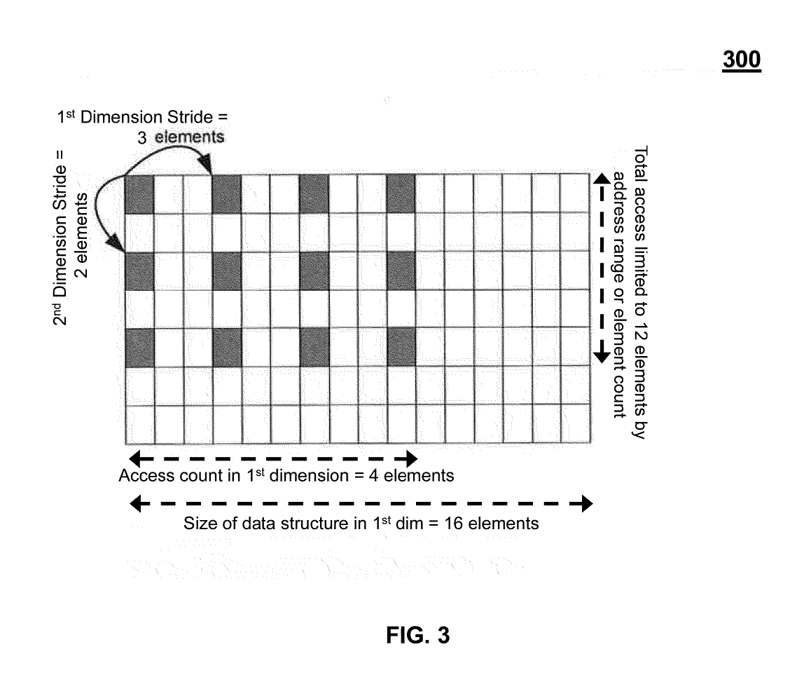

FIG. 3 illustrates an exemplary implementation of multi-dimensional strided access 300, e.g., a stride of three (3) elements in a first dimension and a stride of two (2) elements in a second, orthogonal dimension. FIG. 3 illustrates the use of size of data structure in a particular dimension, and the use of a total access limit through an indication of an address range or element count. With respect to the size of data structure feature, FIG. 3 illustrates that the size of the data structure in the first dimension is limited to 16 elements for the purpose of a multi-dimensional strided access instruction. Thus, although the array may extend well beyond 16 elements in that particular dimension, only the 16 elements are accessible through a multi-dimensional strided access with this feature. With respect to the total access limit feature, FIG. 3 illustrates that the multi-dimensional strided access in the array is limited either by the count in a particular dimension (e.g., an access count in the first dimension of 4 elements) or by a total count (or the equivalent address range) of 12 elements.

Multi-Dimensional Strided Access with Transpose:

A multi-dimensional strided access with transpose is similar to the multi-dimensional strided access above, but this access allows the transposition of two (2) or more dimensions. In this case, an exemplary descriptor specifies the order of transposed dimensions (with respect to the order that the data is stored in memory) in addition to the descriptors described above under “multi-dimensional strided access.”

Indirect Access:

An indirect access is a sequence of data elements whose starting addresses in memory are specified by a sequence of indices stored in memory. The indices may directly specify absolute memory addresses or specify relative offsets into a data structure. In this case, an exemplary descriptor specifies: (1) the sequence of indices in memory, which may be specified using any of the sequential, uni-dimensional strided, or multi-dimensional strided forms described above; (2) the size of each data element to access, which may indicate a standard unit of access such as a byte, a word, or a larger aggregation such as a data record with multiple fields; (3) the base address of the data structure to access, if indices are relative offsets; and (4) optionally, a count of the elements to access (alternatively, the count of elements to access may be implicitly determined by the size of the sequence of indices).

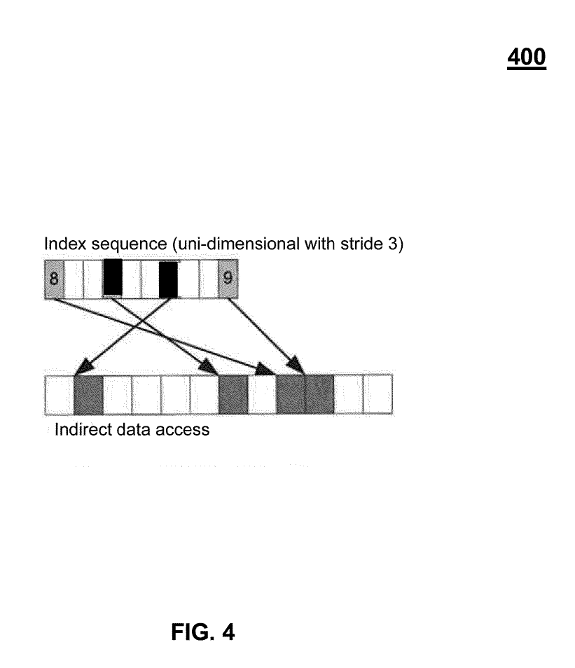

FIG. 4 illustrates an exemplary implementation of indirect access 400, with a sequence of indices provided that indirectly provide the address information for which the data access is required. In this exemplary illustration, the indices are accessed with a stride of three (3) elements.

Application-Specific Patterns:

An application-specific pattern is a pre-defined access pattern found in common application classes (e.g., fast Fourier transform (FFT) butterfly permutations). These application-specific patterns may require additional descriptor fields associated with the particular applications. For example, an FFT butterfly permutation requires an additional argument that specifies the block size for swapping elements.

Reversals:

A reversal pattern is any of the above access patterns that may be reversed by appropriately modifying the descriptor field. For example, the start and end addresses can be switched. With respect to strided accesses, negative strides provide a reversal. Reversing the index sequence for an indirect access also applies. Alternative implementations may support an explicit “reverse” flag in the descriptors for all or some of the access patterns.

Rotations:

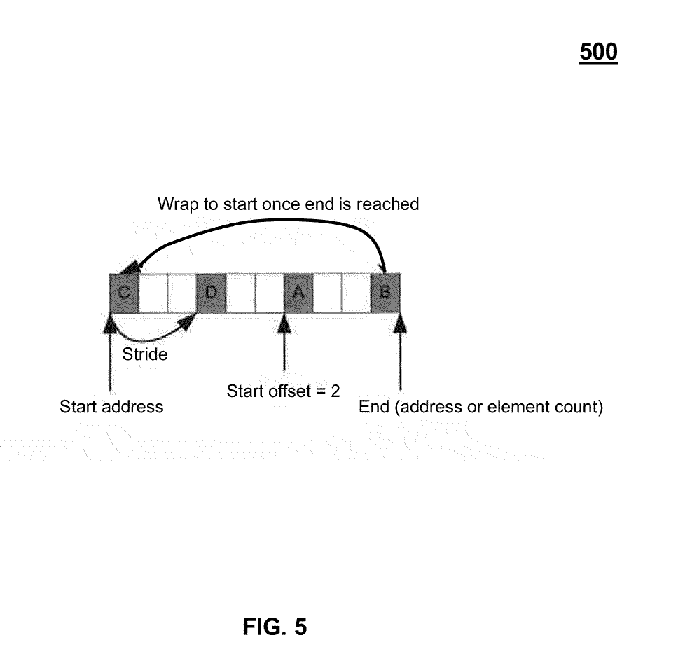

A rotation pattern is any of the above access patterns that can support rotate operations by adding a “Start offset” field to the descriptor. In such cases, the memory accesses start at a “start offset” number of elements into the basic access pattern and wrap around to the beginning at the end of the base access pattern. An exemplary embodiment is illustrated in FIG. 5, where the basic access pattern is a uni-dimensional strided access pattern with a stride of three (3) elements, with a starting offset of two (2). In this exemplary embodiment, the access sequence begins at the starting offset until the memory access limit (e.g., address limit or element count limit) is reached. The next data element is then located at the beginning of the memory (a “wrap around” has occurred), with subsequent elements identified using the stride of three (3) elements. Alternative embodiments may support rotations by issuing multiple compound operations for each contiguous segment of a rotation operation.

Nested Combinations:

A nested combination is a combination of any of the above access patterns that can be supported in nested formations. For example, a nested strided-indirect is a sequence of indirect accesses (using an index stream) that are performed starting at each address identified by a strided pattern. Such nested accesses may be useful when extracting a subset of fields (specified by the index sequence) from a collection of records (where the starting address of each record is specified by the strided pattern).

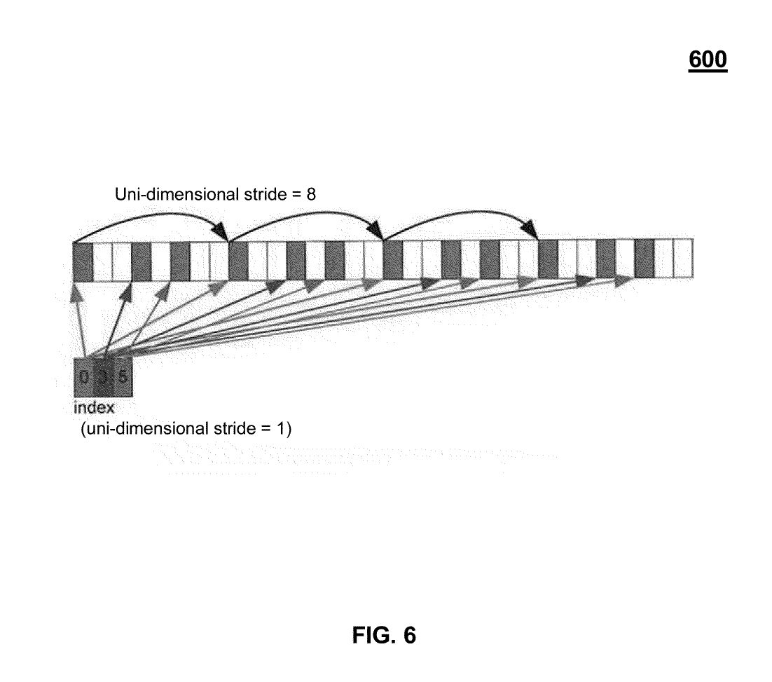

FIG. 6 illustrates an exemplary implementation of a strided-indirect nested access 600, with a sequence of indices provided that is to be applied at element locations that are separated by a stride. In this exemplary illustration, the index sequence contains the indirect access values of 0, 3 and 5. The index sequence is applied to a uni-dimensional stride of eight (8). Thus, each starting element location (for indirect nested purposes) is separated from the next element location by eight (8) elements. At each starting element location, access is made to the elements that are offset by 0, 3 and 5 elements from the starting element location.

Each of the above access patterns may be coupled with optional mechanisms to selectively disable specific element accesses in the compound memory operation, which may include (but are not limited to): (1) bit vectors that specify which elements in the address sequence to access and which elements to skip; and (2) one or more windows of addresses, where element accesses that fall outside said window(s) are skipped.

Furthermore, the above memory operations can be performed or partially performed based on certain conditions. For example, it may be useful to transfer data from one location to another as long as a certain condition is met (e.g., the element being transferred is non-zero).

Compound memory operations can be applied to various memory operations including memory loads, memory stores, and memory-to-memory transfers. Each is described in more detail below.

Loads:

A compound memory load reads the memory accesses specified by an access pattern descriptor and returns the results to the processor that issued the compound memory operation. The processor-memory interface is modified to allow the processor to issue compound loads (by dispatching a compound load operation code (op-code) and an associated memory access pattern descriptor) and to accept the sequence of data elements that are returned from the memory. The processor may place these data elements in registers or on-chip memories.

Some embodiments can place these data elements in registers or storage elements in the logic associated with the memory stack. In some embodiments, a queue may be provisioned for the data returns so that the processor's execution may proceed asynchronously to the data returns from memory except on the uses of the returned data. The memories may also support throttling mechanisms if the processor consumes data slower than the memory is able to provide them.

In some embodiments, the memory system may return the data of a compound memory load in the order specified by the descriptors' access pattern. In other embodiments, the data may be returned out of order. In the latter cases, the memory can tag each data element with a sequence ID to enable recreation of the original order at the processor.

Stores:

A compound memory store writes the memory locations specified by an access pattern descriptor with data sent by the processor that issued the compound memory operation. The processor-memory interface is modified to allow the processor to issue compound stores (by dispatching a compound store op-code and an associated memory access pattern descriptor) and to send the sequence of data elements that are to be written to memory. The processor may send these data elements from registers or on-chip memories. Some alternative embodiments may source these data elements in registers or storage elements in the logic associated with the memory stack. In some embodiments, a queue may be provisioned for the data elements so that the processor's execution may proceed asynchronously to the data sends to memory except on backpressure due to queue-full situations.

In some embodiments, the processor may send the data of a compound memory store in the order specified by the descriptors' access pattern. In other embodiments, the data may be sent out of order. In the latter case, the processor may tag each data element with a sequence ID to enable writing to the appropriate locations at the memory in the appropriate order.

Memory-to-Memory Transfers:

A compound memory-to-memory transfer reads the memory locations specified by one access pattern descriptor and writes them to memory locations specified by another access pattern descriptor. The processor-memory interface is modified to allow the processor to issue compound memory-to-memory transfers (by dispatching a compound transfer op-code and two associated memory access pattern descriptors). Some implementations can also provide mechanisms to signal completion of the transfer operation back to the processor. Memory-to-memory transfers may be used to transfer data between the same type of memory (e.g., DRAM to DRAM transfers) or different types of memory (e.g., DRAM to non-volatile RAM transfers).

In some embodiments, multiple compound memory operations can be supported in parallel, possibly consisting of a mix of loads, stores and transfers. In such cases, an ID can be associated with each compound operation and each element data transfer may be tagged with the ID of the compound operation it belongs to in order to facilitate proper associations at the memories and/or processors. Such an embodiment can replicate the hardware resources for handling compound memory operations (at the memories and/or at the processors) or time-multiplex the hardware resources or both.

The logic layer of the memory stack or the interposer implements the breaking up of each compound memory operation into its basic components (i.e., atomic data element accesses in memory) and implements performing those accesses. This includes the logic to perform address calculations for walking through the access patterns specified by descriptors. It can also include logic to optimize the order in which memory locations are accessed or the amount of data obtained per access to improve performance and/or energy efficiency.

Some embodiments can restrict the span of data accessed by a single compound memory operation (e.g., to not span DRAM row boundaries or to not span operating system (OS) page boundaries).

Implementations that specify address descriptors in terms of physical or virtual addresses are also within the scope of the embodiments. Note that virtually addressed descriptors require the logic layers stacked with memory to have access to virtual-to-physical address translations (e.g., via an input/output memory management unit (IOMMU) interface).

The logic layer can operate on cacheable or non-cacheable data. When using the former, the logic layer initiates snoops for all referenced data. Utilizing a snoop filter located in the memory stack can greatly improve the performance and/or energy/power efficiency.

In some examples, normal memory operations can be interleaved with compound memory operations (and possibly intermixed with data elements belonging to compound memory operations). This can occur when the operations are differentiated and contain their own control and address information.

The logic attributed to the logic layer stacked with memory in the above descriptions may also be implemented in an interposer stacked with memory and/or processors.

Implementations of compound memory operations that span multiple memory stacks within the system are also covered by the scope of the embodiments. Such implementations may be realized by one or more of the following techniques or other similar means: (1) implement compound memory operation logic on a shared interposer; (2) processor(s) issue(s) separate compound memory operations to each memory stack that correspond to the subset of the desired overall compound operation that maps to that memory stack; and/or (3) the full compound memory operation is broadcast to all memory stacks but each stack only performs the accesses that are mapped to its subset of the system's memory. This may be achieved via masking or by implementing system-wide memory-map awareness on each channel. System components (e.g., processor, memory, and/or interposer) are responsible for directing/routing data elements to the appropriate consumers for all operations. Some implementations may support direct stack-to-stack communications interfaces to enable the multiple stacks to coordinate compound operations that span multiple stacks and/or transfer data values necessary to perform these operations. Sequence IDs may be used to maintain ordering across data elements of multiple memory stacks.

Operating System (OS) Implications:

To support compound memory operations that operate on virtual addresses, the memory stack must be able handle the case when certain sub-operations fail due to page faults. Some possible solutions are the memory stack may squash the entire compound memory operation or it could track the faulting addresses in a bit mask. The resulting faults would then be communicated back to the OS and handled appropriately to ensure forward progress.

Compound operations may also be exposed as atomic transactions that are implemented as a sequence of simple scalar memory operations underneath. For instance, the memory stack may include a transaction-based co-processor (interface) that translates a compound memory operation to a series of scalar memory operations within an atomic region. If faults are encountered, the transaction-based co-processor could either immediately abort the transaction on the first identified fault, or it could record the faults so that they can be later communicated to the OS (depending on the fault model). If the co-processor is recording the faults, then when the transaction is about to complete, the co-processor could decide to abort the entire transaction, including the possible successful sub-operations, or the co-processor could allow the successful sub-operations to complete by “finishing” the transaction. If the latter (i.e., allowing the successful sub-operations to complete), then only the unsuccessful sub-operations would have to be re-tried when the compound operation is restarted. A primary benefit of this approach is that the fault model of compound memory operations could be adjusted dynamically by reprogramming the transaction-based co-processor.

As noted above, some embodiments offer a number of advantages. For example, when a logic layer stacked with memory is available, some embodiments reduce the energy and performance overheads associated with address and command communication for pre-defined memory access patterns. Compound memory operations also communicate richer access pattern information directly to the memories (instead of individual element accesses). This may enable better optimization of memory access scheduling as the logic layer of the memory stack now has visibility of macro-level access patterns, including future data element accesses.

With a single compound memory operation, large amounts of data can be transferred between the processor and memory (in the case of compound loads and stores) or between multiple memory locations (in the case of compound memory transfers). This can result in more efficient data transfers (e.g., burst data transfers) that improve performance and energy efficiency. Some implementations may provide temporary storage on the logic layer (or interposer) to allow aggregation of data to enable such efficiency enhancements. Similar temporary storage may also be provisioned on the processor side for aggregating store data for efficiency.

Having the logic layer of the memory stack or the interposer break up each compound memory operation into its basic components is more efficient than doing this in the processor or memory controller, since such a memory stack architecture reduces the number of addresses and commands that are sent across the memory bus and allows the scheduling of memory accesses to be better optimized for the particular implementation of the stacked memory. On indirect accesses, where the index sequence is already stored in memory, compound memory operations eliminate the need to read the indices in to the processor to compute the data address and issue the memory operations, thereby eliminating an extra round-trip to memory improving both performance and energy consumption.

Implementing the compound memory operation mechanisms directly in the memory is expensive and not very practical. This is because the placement of logic in a memory chip (as opposed to a separate logic chip as described herein) incurs significant costs in the memory chips, and the performance is limited due to the inferior performance characteristics of the transistors used in memory manufacturing processes.

Processors (the term “processor” is used herein generically to refer to anything that accesses memory in a computing system) typically load and store data from/to memory by issuing addresses and control commands on a per-data-item (where a data item may be a byte, a word, a cache line, etc.) basis. This requires a separate address and one or more commands (some memory technologies, such as DRAM, may require multiple commands for some or all access) to be transmitted from the processor to memory for each access even though the sequence of accesses follows a pre-defined pattern (e.g., a sequential stream). The transmission of addresses and commands consumes power and may introduce performance overheads in cases where the address/command bandwidth becomes a bottleneck. Furthermore, issuing addresses and control commands on a per-data-item basis may limit opportunities to optimize memory accesses and data transfers.

Memory systems can be implemented using multiple silicon chips within a single package, for example a memory chip three-dimensionally integrated with a logic/interface chip. The additional logic chip provides opportunities to integrate additional functionality not normally provided by memory systems. The functionality of this logic chip could be implemented on a silicon interposer on which the memory chips as well as other processing chips are stacked. Some embodiments use the logic functions to reduce address and command traffic for certain access patterns. The embodiments also provide opportunities to optimize memory accesses and data transfers.

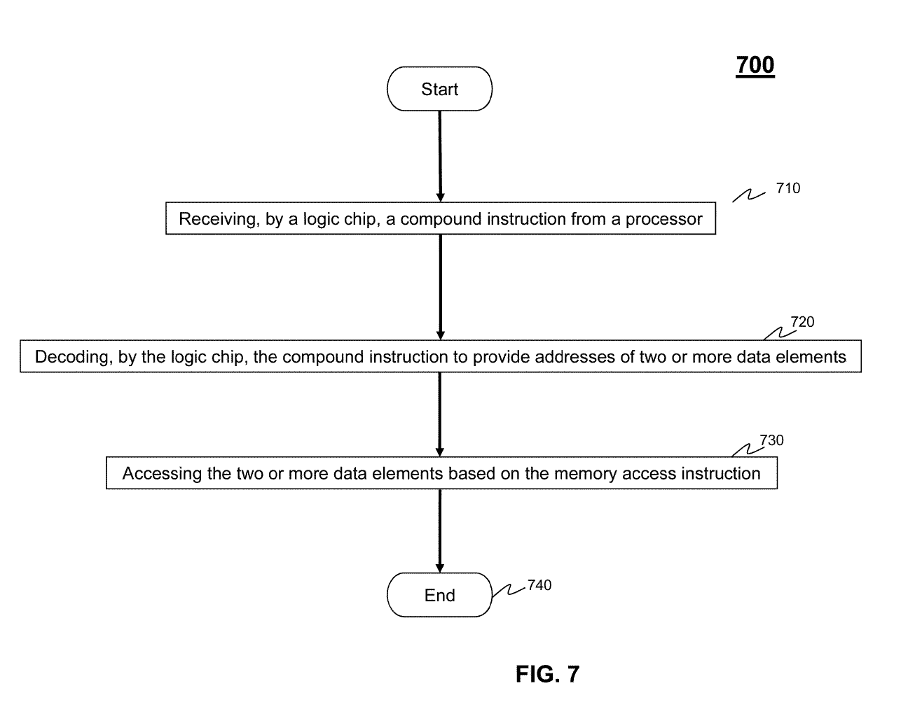

FIG. 7 provides a flowchart of a method 700 that executes a compound memory instruction, according to an embodiment. It is to be appreciated the operations shown may be performed in a different order, and in some instance not all operations may be required. It is to be further appreciated that this method may be performed by one or more logic chips that read and execute these access instructions.

The process begins at step 710. In step 710, a compound instruction is received by a logic chip from a processor, wherein the compound instruction includes a memory access instruction and one or more descriptors.

In step 720, the compound instruction is decoded by the logic chip to provide addresses of two or more data elements based on the one or more multiple descriptors.

In step 730, the two or more data elements are accessed based on the memory access instruction.

In step 740, method 700 ends.

The embodiments described, and references in the specification to “some embodiments,” indicate that the embodiments described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with particular embodiments, it is understood that it is within the knowledge of one skilled in the art to effect such feature, structure, or characteristic in connection with other embodiments whether or not explicitly described.

Some embodiments may be implemented in hardware, firmware, software, or any combination thereof. For example, logic layer 120 in FIG. 1 may be implemented as a computing device that can execute computer-executable instructions stored on a computer readable medium as follows. Some embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the inventive subject matter such that others can, by applying knowledge within the skill of the art, readily modify and/or adapt for various applications such specific embodiments, without undue experimentation, without departing from the general concept of the inventive subject matter. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method, comprising:
receiving, by a logic chip, a compound instruction from a processor, wherein the compound instruction includes a memory access instruction and one or more descriptors;
decoding, by the logic chip, the compound instruction to provide addresses of two or more data elements in a memory chip, wherein the decoding is based on the one or more descriptors; and
accessing the two or more data elements based on the memory access instruction.

2. The method of claim 1, wherein the one or more descriptors includes one of (a) a range of addresses, or (b) a start address and an element count.

3. The method of claim 1, wherein the one or more descriptors includes a distance between adjacent data elements to be accessed together with one of (a) a range of addresses, or (b) a start address and an element count.

4. The method of claim 1, wherein the one or more descriptors includes a size of a data structure being accessed and one or more distances, in one or more dimensions, between adjacent data elements to be accessed together with one of (a) a range of addresses, or (b) a start address and an element count.

5. The method of claim 1, wherein the one or more descriptors includes an order of transposed dimensions, a size of a data structure being accessed, and one or more distances, in one or more dimensions, between adjacent data elements to be accessed together with one of (a) a range of addresses, or (b) a start address and an element count.

6. The method of claim 1, wherein the one or more descriptors includes a sequence of indices in memory, a size of the two or more data elements, and a base address relative to which the indices indicate the addresses of the two or more data elements.

7. The method of claim 1, wherein the one or more descriptors includes a pre-defined access pattern associated with a computational application.

8. The method of claim 1, wherein the one or more descriptors includes a reversal descriptor indication.

9. The method of claim 1, wherein the one or more descriptors includes a rotation indication together with a start offset of the two or more data elements.

10. The method of claim 1, wherein the one or more descriptors includes a nested combination of two or more of the one or more descriptors.

11. The method of claim 1, wherein the one or more descriptors includes a bit vector or an address window, and wherein the accessing the two or more data elements includes skipping other data elements based on the bit vector or the address window.

12. The method of claim 1, wherein the memory access instruction includes a data transfer instruction, the one or more descriptors includes a condition, and the accessing the two or more data elements includes accessing the two or more data elements if the condition being met.

13. The method of claim 1, wherein the memory access instruction is an atomic transaction comprising a sequence of a plurality of scalar memory operations, and wherein the accessing the two or more data elements includes executing the plurality of scalar memory operations to access the two or more data elements.

14. The method of claim 1, wherein the decoding by the logic chip further includes decoding by the logic chip mounted in a stacked memory, the stacked memory further including the memory chip.

15. An apparatus, comprising:
a memory chip; and
a logic chip coupled to the memory chip to form a memory device, wherein the logic chip is configured to:
receive a compound instruction from a processor, wherein the compound instruction includes a memory access instruction and one or more descriptors;
decode the compound instruction to provide addresses of two or more data elements in the memory chip, wherein the decoding is based on the one or more descriptors; and
access the two or more data elements based on the memory access instruction.

16. The apparatus of claim 15, wherein the one or more descriptors includes one of (a) a range of addresses, or (b) a start address and an element count.

17. The apparatus of claim 15, wherein the one or more descriptors includes one or more distances, in one or more dimensions, between adjacent data elements to be accessed together with one of (a) a range of addresses, or (b) a start address and an element count.

18. The apparatus of claim 15, wherein the one or more descriptors includes a size of a data structure being accessed and one or more distances, in one or more dimensions, between adjacent data elements to be accessed together with one of (a) a range of addresses, or (b) a start address and an element count.

19. The apparatus of claim 15, wherein the one or more descriptors includes an order of transposed dimensions, a size of a data structure being accessed, and a distance between adjacent data elements to be accessed together with one of (a) a range of addresses, or (b) a start address and an element count.

20. The apparatus of claim 15, wherein the one or more descriptors includes a sequence of indices in memory, a size of the two or more data elements, and a base address relative to which the indices indicate the addresses of the two or more data elements.

21. The apparatus of claim 15, wherein the one or more descriptors includes a pre-defined access pattern associated with a computational application.

22. The apparatus of claim 15, wherein the one or more descriptors includes a reversal descriptor indication.

23. The apparatus of claim 15, wherein the one or more descriptors includes a rotation indication together with a start offset of the two or more data elements.

24. The apparatus of claim 15, wherein the one or more descriptors includes a nested combination of two or more of the one or more descriptors.

25. The apparatus of claim 15, wherein the one or more descriptors includes a bit vector or an address window, and wherein the logic chip is further configured to access the two or more data elements by skipping other data elements based on the bit vector or the address window.

26. The apparatus of claim 15, wherein the memory access instruction includes a data transfer instruction, the one or more descriptors includes a condition, and the logic chip is further configured to access the two or more data elements if the condition being met.

27. The apparatus of claim 15, wherein the memory access instruction is an atomic transaction comprising a sequence of a plurality of scalar memory operations, and wherein the logic chip is further configured to access the two or more data elements by executing the plurality of scalar memory operations.

28. The apparatus of claim 15, wherein the logic chip and the memory chip are mounted together to form a stacked memory.

29. A non-transitory computer-readable medium having stored thereon computer-executable instructions, execution of which by a computing device cause the computing device to perform operations comprising:
receiving a compound instruction from a processor, wherein the compound instruction includes a memory access instruction and one or more descriptors;
decoding the compound instruction to provide addresses of two or more data elements in a memory chip, wherein the decoding is based on the one or more descriptors; and
accessing the two or more data elements based on the memory access instruction.
